(19) United States
(12) Patent Application Publication
(10) Pub. No.: US 2009/0146336 A1
(43) Pub. Date: Jun. 11, 2009

(54) Process for making shrink films with embossed optical or holographic devices

(75) Inventor: George Masi, Toms River, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: R Tape Corporation

(21) Appl. No.: 12/322,600

(22) Filed: Feb. 4, 2009

Related U.S. Application Data
(63) Continuation-in-part of application No. 11/906,728, filed on Oct. 2, 2007.

(51) Int. Cl. B29C 47/00

(52) U.S. Cl. 264/166; 264/176.1

(57) ABSTRACT

The present invention provides a process for manufacturing an embossed shrink film having one or more embossed devices such as optical devices, optical lenses, holographic images, holographic textures, static images, textured patterns, and graphical text. An embossing tool is provided having a raised image corresponding to the embossed device and a film is embossed by extruding the film across the embossing tool to form the embossed devices in the film. The embossed film is tentered, proportionally stretching the embossed devices along with the film. The tentered film is stored for subsequent forming into a sleeve of film that can be placed about a product and shrunk by heating to form a contoured shrink film on the product, the film retaining the embossed devices in proportion to the shrinkage of the film.

### CROSS REFERENCE TO RELATED APPLICATIONS

This application is a continuation-in-part of commonly owned U.S. patent application Ser. No. 11/906,728, filed on Oct. 2, 2007, which is incorporated herein by reference in its entirety.

### FIELD OF INVENTION

The present invention relates to a process for manufacturing decorative shrink films, and more particularly to a process for manufacturing embossed plastic shrink films having optical devices such as holographic images, holographic textures, optical lenses, static images, graphical text, and the like, separately or in combination with tactile textures and patterns.

### BACKGROUND OF INVENTION

Embossed films have long been popular for making signage or other products having special effects such as images or backgrounds that appear to be three-dimensional or that create other optical effects or illusions. Such products are used in visual communications, graphic arts, and packaging applications. These three-dimensional illusions are created by embossing a texture or pattern into one side of a film and viewing the embossed image from an opposite side of the film. Different plastic films may be embossed for making decorative signs or other products, each having its own set of physical properties and performance characteristics that are suited to particular applications.

Shrink film is a plastic film that is commonly used to shrink wrap a variety of items and products ranging from compact disks to large appliances. A shrink Film is made by tentering the film, i.e., stretching a film at an elevated temperature, causing the molecules in the film to change from a random pattern to instead become oriented in the direction of stretching. Although the film snaps back somewhat when released, cooling of the stretched film sets the film and retains the molecules in their aligned orientation. Subsequent reheating causes the film to shrink back toward its initial size in the direction of stretching. The film can be stretched in one direction (to create a unidirectional shrink film) or in two directions (to create a bidirectional shrink film), thereby creating a film that will shrink back under heat in one or two directions, respectively.

It has previously not been possible to create optical devices, holographic devices, or tactile patterns in shrink film such that the optical devices, holographic devices, or tactile patterns are capable of surviving the tentering and snapping back of the film after embossing, as well as the heat shrinking of the film. Accordingly, it would be advantageous to provide process for embossing optical or holographic devices or features, including optical lenses and holographic images or textures, or tactile textures and patterns, onto a shrink film such that the optical or holographic devices and tactile patterns are capable of surviving the tentering and snapping back, as well as the heat shrinking, of the film.

### SUMMARY OF INVENTION

The present invention provides processes for making embossed plastic shrink films having embossed devices such as optical devices and holographic devices that is capable of surviving the tentering, snapping back, and heat shrinking of the film.

In one embodiment, the present invention provides a process for manufacturing a shrink film having one or more embossed devices. The process includes providing an embossing tool shaped to form one or more embossed devices in a film, embossing the film by contacting the embossing tool with the film to form the one or more embossed devices in the film, tentering the film, and storing the tentered film for subsequent heat shrinkage.

In another embodiment, the present invention provides a process for manufacturing a shrink film having at least one embossed device. The process includes providing an embossing tool shaped to form the at least one embossed device, extruding the film across the embossing tool to form the at least one embossed device in the film, tentering the film, and storing the tentered film for subsequent heat shrinkage.

In yet another embodiment, the present invention provides a process for making a shrink film for use in decorating a portion of a product, the film having at least one embossed device. The process includes providing an embossing tool shaped to form the at least one embossed device, extruding the film across the embossing tool to form the at least one embossed device in the film, tentering the film, and shrinking the film by heating the film above a threshold temperature.

Other objects, advantages, and features of the present invention will become apparent to those skilled in the art upon reading the following detailed description, when considered in conjunction with the appended claims and the accompanying drawings briefly described below.

### BRIEF DESCRIPTION OF DRAWINGS

The accompanying drawings, which are incorporated herein and constitute a part of this specification, illustrate preferred embodiments of the invention, and together with the general description given above and the detailed description given below, serve to explain features of the invention. However, it should be understood that this invention is not limited to the precise arrangements and instrumentalities shown in the drawings.

FIG. 1 is a schematic overview of a process according to the present invention.

FIG. 2 is a schematic of a process for creating an embossing tool.

FIG. 3 is a schematic of a process for transferring an image to a flexographic embossing tool.

FIG. 4 is a schematic of a process for embossing a film.

FIG. 5 is a schematic overview of a process according to the present invention.

FIG. 6 is a schematic overview of another process according to the present invention.

FIG. 7 is a schematic overview of a further process according to the present invention.

FIG. 8 is a schematic overview of yet another process according to the present invention.

FIG. 9 shows a cross-sectional view of a flexographic plate before image transfer.

FIG. 9A shows a cross-sectional view of a flexographic plate after image transfer.

FIG. 10 is shows a cross-sectional view of a flexographic plate after second side UV-A exposure.

FIG. 10A shows a cross-sectional view of a flexographic plate after first side UV-A exposure.

FIG. 11 show a cross-sectional view of a flexographic plate after thermal processing.

FIG. 11A shows a cross-sectional view of a flexographic plate after post-thermal processing curing.

FIG. 11B shows a cross-sectional view of a flexographic plate after post-thermal processing finishing.

FIG. 12 shows a cross-sectional view of a flexographic plate being used to emboss a film.

FIG. 13 shows a cross-sectional view of a flexographic plate being used to emboss an embossing belt.

FIG. 14 shows a cross-sectional view of an embossing belt being used to emboss a film.

### DETAILED DESCRIPTION OF THE ILLUSTRATED EMBODIMENTS

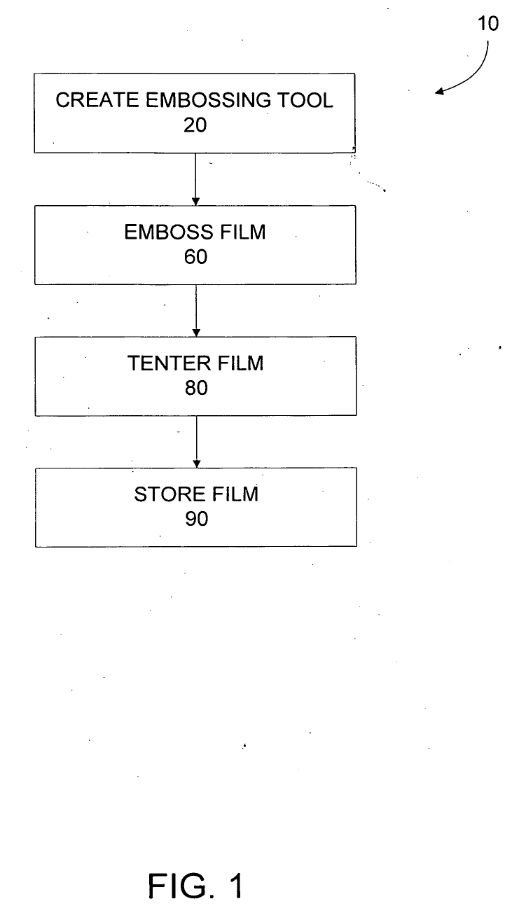

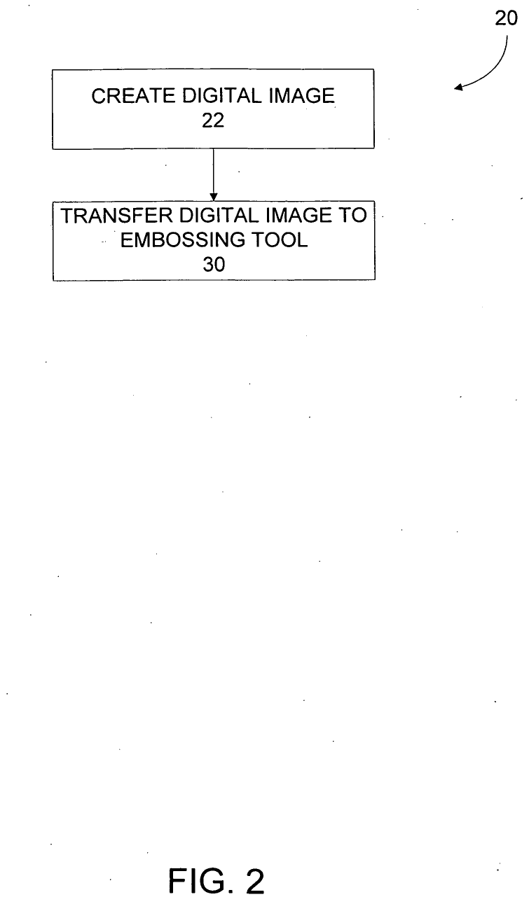

The present invention provides a process for manufacturing a plastic shrink film having an embossed optical or holographic device. Various embodiments of a process form manufacturing an embossed shrink film are illustrated schematically in FIGS. 1, 5, 6, 7, and 8. Embodiments of several stages of a process for manufacturing an embossed shrink film are illustrated schematically in FIGS. 2, 3, and 4.

FIG. 1 depicts an embodiment 10 of a process for manufacturing a shrink film comprising the steps of providing an embossing tool 20, embossing a film 60, tentering the film 80, and storing the film 90 for later heat shrinking. The heat shrinking of the film would be performed by the end user. FIG. 2 depicts an embodiment of the step 20 of providing an embossing tool comprising the steps of creating a digital image 22 and transferring the digital image to an embossing tool 30.

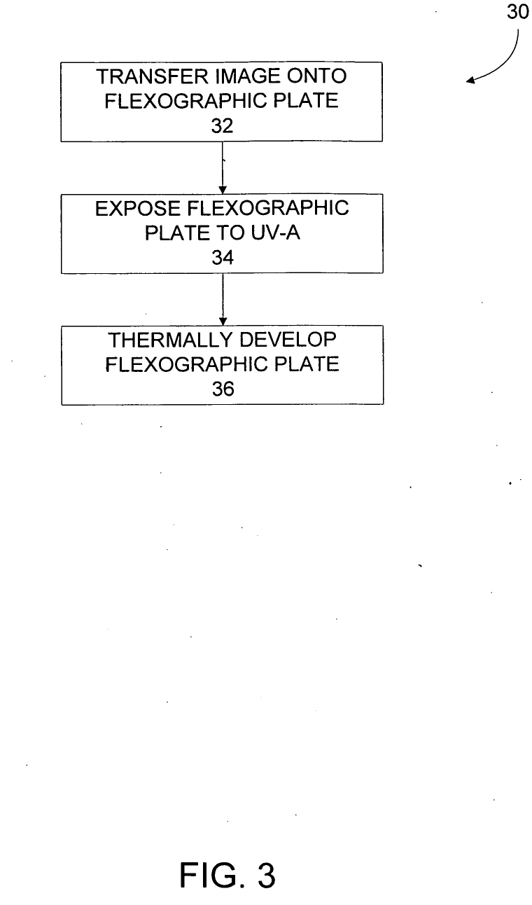

In one embodiment, the embossing tool comprises one or more nickel shims manufactured from electroformed nickel, the shims having raised images shaped to form the embossed devices into the film. In another embodiment, the embossing comprises a flexographic plate formed by a process depicted schematically in FIG. 3, including transferring the image onto a flexographic plate 32, exposing the flexographic plate to UV-A radiation 34, and thermally developing the flexographic plate 36. Processes of forming a flexographic plate and using a flexographic plate to emboss a film are described in U.S. patent application Ser. No. 11/906,728, the parent of the instant application.

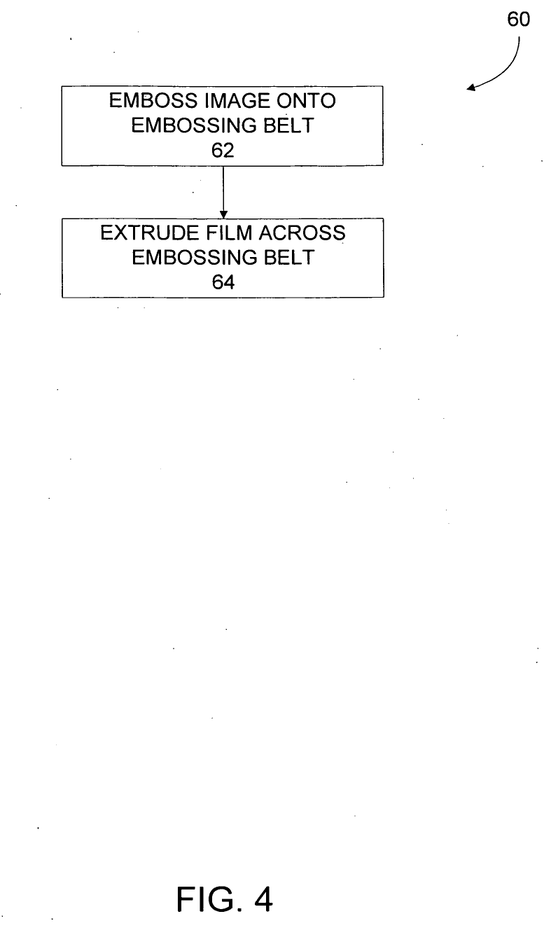

In one embodiment, the embossing step 60 comprises directly contacting the embossing tool with the film and forming the embossed devices into the film. In another embodiment, as depicted schematically in FIG. 4, the embossing step 60 comprises embossing the image from the embossing tool onto an embossing belt 62 and then extruding the film across the embossing belt 64 to transfer the embossed device to the film.

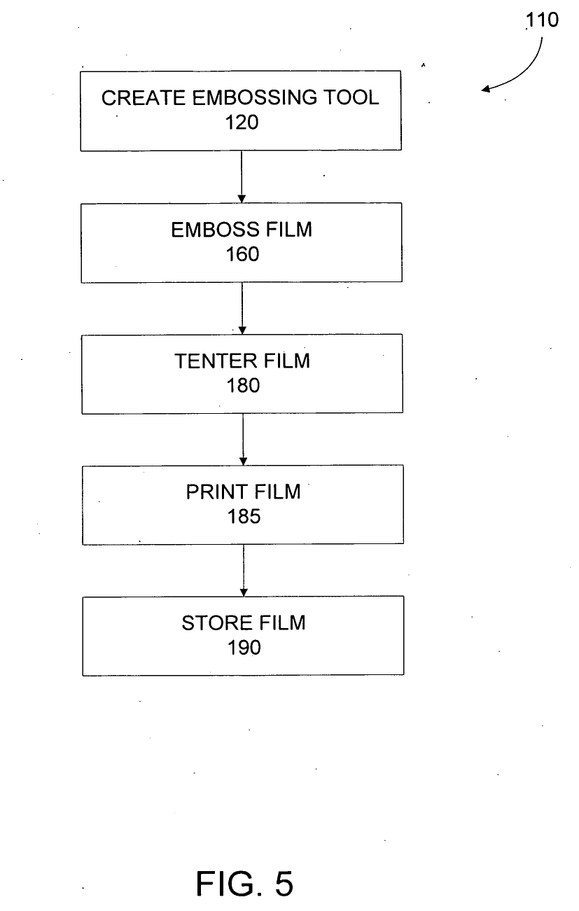

FIG. 5 depicts another embodiment 110 of a process for manufacturing a shrink film comprising the steps of providing an embossing tool 120, embossing a film 160, tentering the film 180, printing the film 185, and storing the film 190 for later heat shrinking. The step 185 of printing the film can occur before or after the step 180 of tentering the film. The heat shrinking of the film would be performed by the end user.

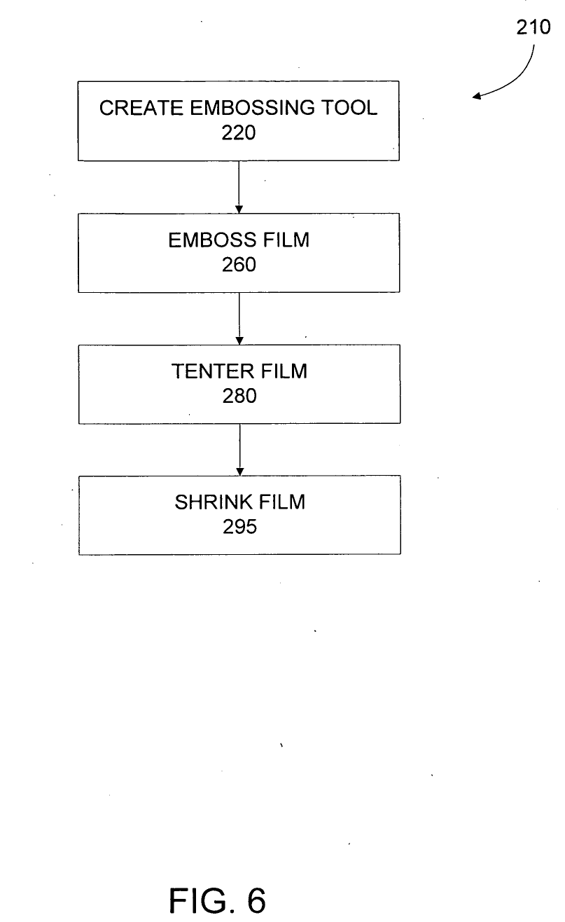

FIG. 6 depicts another embodiment 210 of a process for manufacturing a shrink film comprising the steps of providing an embossing tool 220, embossing a film 260, tentering the film 280, and shrinking the film 295.

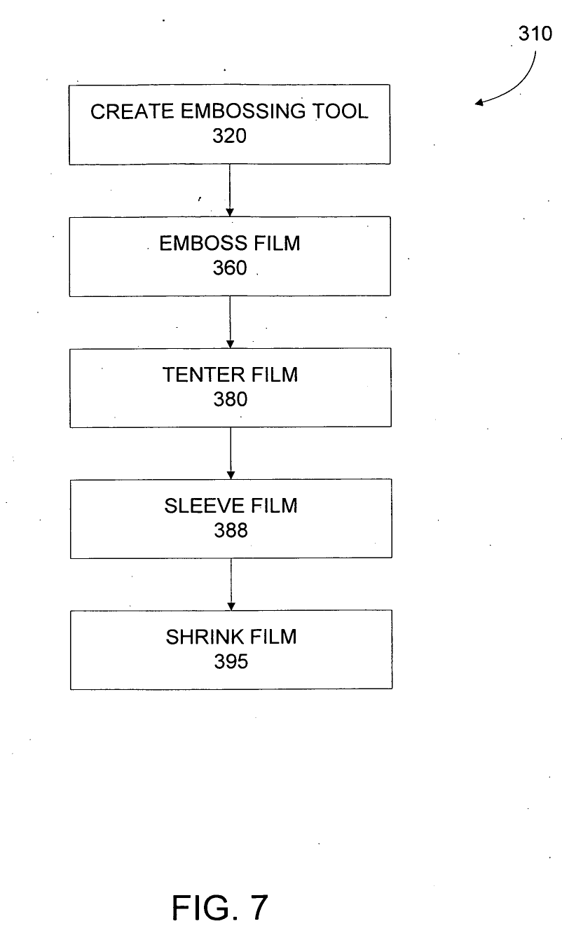

FIG. 7 depicts another embodiment 310 of a process for manufacturing a shrink film comprising the steps of providing an embossing tool 320, embossing a film 360, tentering the film 380, sleeving the film 388, and shrinking the film 395. The step 388 of sleeving the film includes rolling up the film and adhering one portion of the film to another portion of the film so that the sleeve of film retains a generally cylindrical shape.

The embodiment 10 of the process will be described with reference to FIG. 1. In the step 20 of providing an embossing tool, an embossing tool can be created from a metal shim such as electroformed nickel, or from a flexographic plate. Regardless which type of embossing tool is provided, the step 20 can comprise creating a digital image 22 and transferring the digital image to an embossing tool 30, as shown in FIG. 2.

In the step 22 of creating a digital image, a digital image is prepared including the desired optical or holographic device that will ultimately be embossed into a shrink film. The digital image may be prepared using any standard digital design workstation or system. Such a system may be a commercially available system such as sold by Barco or Artwork Systems (e.g., PCC Artpro), or a PC-based or Macintosh-based system running a suitable design package such as Corel Draw or Adobe® Illustrator.

If a flexographic plate is used to create a shim or embossing tool, the step 30 includes transferring the image onto a flexographic plate 32, exposing the flexographic plate to UV-A radiation 34, and thermally developing the flexographic plate 36, as shown in FIG. 3. The flexographic plate preferably comprises a base layer made from a polymer material. Preferred flexographic plates are available from the DuPont Company and include, for example, Cyrel® DFH, a high durometer high resolution plate, and Cyrel® DFM and Cyrel® DFS, medium durometer high resolution plates. Other similar flexographic plates are available. A medium or high durometer plate can be used, depending on which resin will be used to extrude the film. The Cyrel® flexographic plates are typically sold in thicknesses of 0.045″, 0.067″, 0.100″, and 0.112″. The 0.045″ and 0.067″ thick flexographic plates are capable of being imaged to a relief depth of about 0.018″ to about 0.023″, while the 0.100″ and 0.112″ flexographic plates are capable of being imaged to a relief depth of about 0.020″ to about 0.028″. All of the plates are typically capable of retaining a minimum positive line width of about 3 mil (0.003″) and a minimum isolated dot size of about 5 mil (0.005″). The thickness and durometer rating of the plate can be selected based, at least in part, on the ability of the plate to withstand the heat generated during extrusion of the film and the effectiveness of the extrusion equipment in controlling the interface surface temperature between the plate and the extruded film.

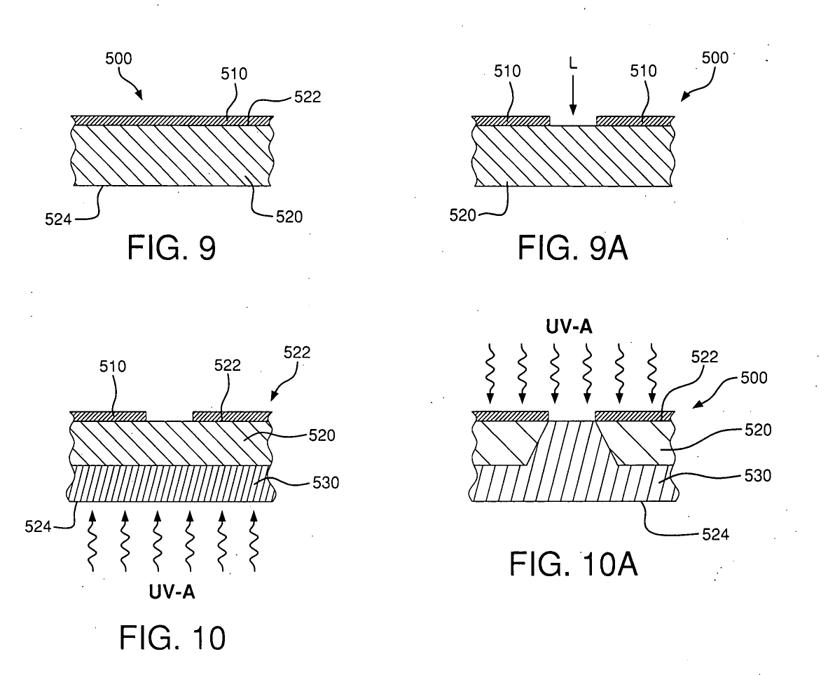

With reference to FIG. 9, a flexographic plate 500 is preferably a photopolymer plate that comprises a polymer layer 520 having a first side 522 and a second side 524, and further comprises a mask layer 510 protecting the first side 522 from light exposure. The mask layer 510 is sensitized to laser light such that it can be selectively etched or ablated by a laser beam. The step 32 of transferring the image onto the flexographic plate 500 is described with reference to FIG. 9A. The digital image is etched into the mask layer 510 using a laser, preferably a fiber laser, to ablate or remove a portion of the mask layer 510 corresponding to the image. The remaining mask layer 510 is essentially a negative of the image, covering (i.e., protecting from light exposure) the portion of the flexographic plate 500 that will eventually be removed to a depth from the first side 522 to form a relief image in the plate 500. In the process 10, the etched image corresponds to the optical device that will subsequently be embossed into a film.

Image transfer may be performed using any one of several commercially available machines designed for this purpose including, for example, Cyrel® Digital Imagers sold under the tradenames Spark 2120, Spare 2530, Spark 4835, Spark 4260, and Compact 4835. Such machines, are adapted to accept digital image file inputs in various formats, including, but not limited to, Adobe® Illustrator, Adobe® PostScript, Adobe® PDF, LEN, and TIFF, as well as proprietary formats such as FlexRip, CDI Spark, CDI Spark XT, and Grapholas®. These digital imagers, as well as other similar machines, typically are capable of etching images onto flexographic plates ranging between about 0.030″ and about 0.255″ in thickness. Images can typically be etched to a resolution of between about 2000 to about 4000 points per inch, with some machines being capable of enhanced resolutions up to about 8000 points per inch.

In the step 34 of exposing the flexographic plate 500, at least two operations are preferably performed. First, as illustrated in FIG. 10, the second side 524 of the flexographic plate 500 is exposed to ultraviolet light preferably in the UV-A range, to establish a floor for the relief image that will be formed in the plate 500. UV-A radiation exposure causes the polymer layer 520 to further polymerize, making it more resistant to elevated temperatures than a non-exposed polymer layer 520. The second side exposure time varies according to the relief desired in the flexographic plate 500: shorter second side exposure times will provide for deeper relief while longer second side exposure times will provide for shallower relief. The depth of relief in the flexographic plate also corresponds to the depth of relief that will be subsequently embossed into a film. For example, if deeper relief is desired in the embossed film, the UV-A exposure time of the second side 524 will be relatively short. In contrast, if shallower relief is desired in the embossed film, the UV-A exposure time of the second side 524 will be relatively long.

Next, as illustrated in FIG. 10A, the first side 522 of the flexographic plate 500 is exposed to ultraviolet light preferably in the UV-A range, preferentially exposing raised portions of the plate 500 corresponding the image that was etched away from the mask layer 510. The time of UV-A exposure of the first side 522 must complement the time of UV-A exposure time of the second side 524 so that the portion of polymer exposed from the first side 522 is of sufficient depth to join the portion of polymer exposed from the second side, as illustrated. For example, if the UV-A exposure time of the second side 524 is relatively short, to create a deeper relief, the UV-A exposure time of the first side 522 must be relatively long. Conversely, if the UV-A exposure time of the second side 524 is relatively long, to create a shallower relief, the UV-A exposure time of the first side 522 need only be relatively short.

The properties of the polymer layer 520 are such that, absent exposure to UV-A radiation (e.g., the portion of the polymer layer 520 shielded from the UV-A radiation by the presence of the mask layer 510), the polymer can be removed by being melted or vaporized or sublimated by exposure to heat (i.e. infrared radiation). However, after exposure to UV-A radiation, the polymer is resistant to heat and substantially retains its solid shape and form when exposed to heat below the level sufficient to melt or vaporize polymer that was not UV-A irradiated. Non-exposed polymer is typically melted or vaporized at temperatures exceeding about 200° F., while exposed polymer is typically resistant to melting or vaporization at temperatures up to about 375° F. The mask layer 510 is similarly subject to melting or vaporization when exposed to heat sufficient to melt or vaporize the non-exposed polymer layer 520 but below that at which the exposed polymer layer 520 could be subject to melting or vaporization. Irradiation of the flexographic plate 500 with UV-A light may be performed using a commercially available machine such as those sold by the DuPont Company as the Cyrel®1000 EC/LF and Cyrelg 2000 EC/LF.

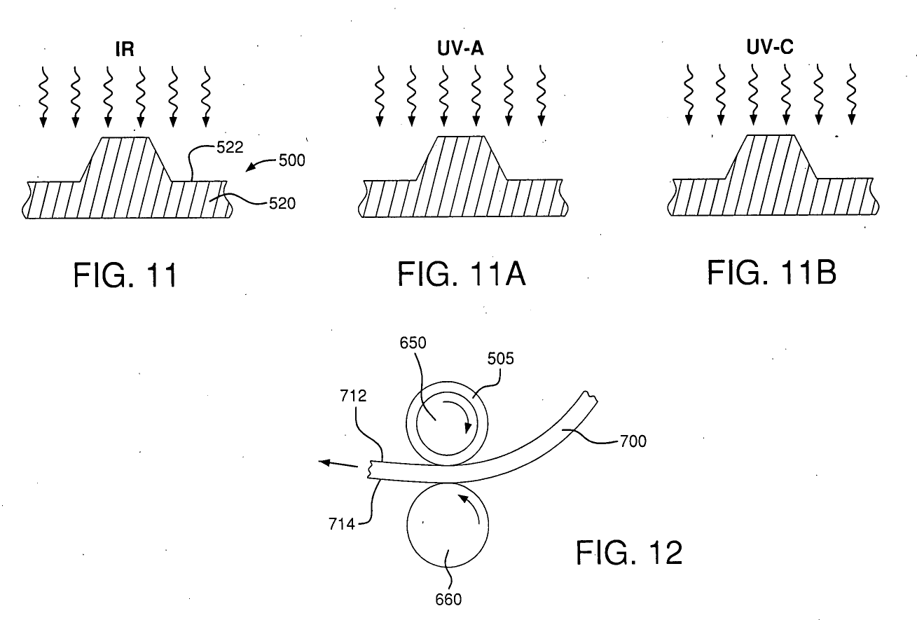

In the step 36 of thermally developing the flexographic plate 500, at least one and as many as three operations are typically performed. First, as shown in FIG. 11, the first side 522 of the plate 500 is exposed to thermal energy or infrared radiation sufficient to cause the remaining mask layer 510 and the polymer layer 520 not exposed to UV-A radiation to melt or vaporize, while allowing the polymer layer 520 exposed to UV-A radiation to remain intact. Second, as shown in FIG. 11A, it may be desirable to expose the remaining plate 500 to a further dose of UV-A radiation to eliminate surface tackiness. Third, as shown in FIG. 11B, it may further be desirable to expose the remaining plate 500 to a dose of UV-C radiation to ensure complete polymerization of the polymer layer 510 of the flexographic plate 500. Thermal developing and post processing of the plate 500 may be performed by a commercially available machine, such as those sold by the DuPont Company as Cyrel® FAST 1000TD and Cyrel® FAST TD4260.

In the step 60 of embossing the film, the film can be embossed directly from a shim (which can be a flexographic plate 500, an electroformed nickel shim, or a shim of another material) by extruding the film across the shim. Alternatively, the image can be transferred first to an embossing belt created as an intermediate shim for transferring the image from the shim to a film, as depicted in FIG. 4. In particular, the image can be embossed onto the embossing belt 62 and the film can then be extruded across the embossing belt 64. In some cases it is preferable to transfer the image directly from the shim to the film, while in other cases it is preferable to use the intermediate embossing belt. An embossing belt is typically between 1200 yards and 2500 yards in length and allows the production of large quantities of embossed film while minimizing the wear and tear to which the shim is exposed, thus prolonging the usable life of the shim. The embossing belt is preferably comprised of a material having made of a hard, more heat stable material than the film to be embossed. For example, for embossing a PVC film, the embossing belt can be made from polycarbonate. An embossing belt is typically about 4 mils to 5 mils in thickness, and the embossed images is the same depth as that desired on the receiving film.

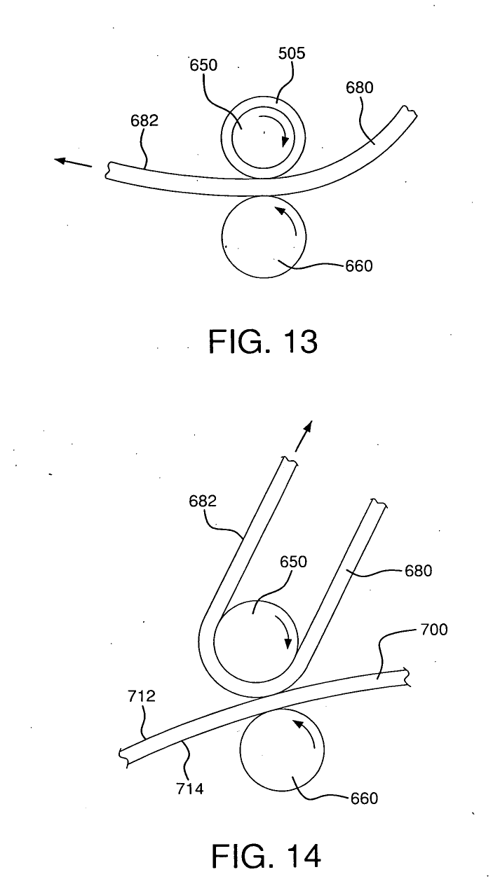

To emboss an embossing belt, a belt of plastic material 680 is embossed with an imprint of the image that was formed on a shim 505. As shown in FIG. 13, the shim 505 is mounted onto a cylindrical embossing roller 650 and the belt 680 is passed between the shim 505 and an opposed roller 660 that presses the belt 680 against the shim 505, forcing the image to be imprinted onto one surface 682 of the belt 680. Thus, the surface 682 of the belt 680 is embossed with a three-dimensional image.

To emboss a film by extrusion, an extruded plastic film 700 comprising a layer of plastic material 710 is embossed with an imprint of the image that was formed in the shim 505, or in the embossing belt 680. In one embodiment, as shown in FIG. 12, the shim 505 is mounted onto a cylindrical embossing roller 650, and the film 700 is passed between the shim 505 and an opposed roller 660 that presses the film 700 against the shim 505, forcing the image to be imprinted into one surface 712 of the film 700, while the other surface 714 of the film 700 remains flat and smooth as a printable surface. The temperature at which the plastic film 700 is embossed ranges from about 350° F. to 550° F., depending on the resin from which the film is made. For example, a PVC film will be embossed at approximately 375° F. The speed at which the plastic film 700 is extruded depends ranges from about 10 to 125 feet per minute, depending on film thickness. For example, a 2 mil thick film may be extruded at approximately 120 feet per minute while a 20 mil thick film may be extruded at approximately 14 feet per minute.

Alternatively, as shown in FIG. 14, the embossing belt 680 is routed across a cylindrical embossing roller 650, and the film 700 is passed between the belt 680 and an opposed roller 660 that presses the film 700 against the embossed surface 682 of the belt 780, forcing the image to be imprinted into a surface 712 of the film 700, while the other surface 714 of the film 700 remains flat and smooth as a printable surface. Thus, the surface 712 of the film 700 is embossed with a replica of the image that was formed in the shim 505. The embossed surface 712 created by the embossing belt 680 is comparable in quality, depth, clarity, and resolution of image to the embossed surface 712 created by the shim 505, except that use of the embossing belt 680 creates a replica of the image formed in the shim 505, while use of the shim 505 itself creates a negative of that image.

The depth and quality of the embossed image can be controlled by multiple parameters, including but not limited to temperature and pressure. In one example, if the temperature is increased, a deeper embossed image is created, and conversely, if the temperature is decreased, a shallower embossed image is created. In another example, if the embossing roll applies greater pressure to the film, a deeper embossed image is created, and if the embossing roll applies less pressure to the film, a shallower embossed image is created. A film 700 that has been imprinted in this manner is termed “embossed” or “coined” to indicate that a three-dimensional image has been made on one surface of the film 700 to create the embossed surface 712. It is important that the printable surface 714 is not deformed so that it can be printed with colors or inks as desired.

The film 700 may be made from various materials suitable for tentering, printing, and subsequent shinking, including but not limited to copolyesters, polyvinylchloride (PVC), polylactide (PLA), and thermoplastic styrene-butadiene copolymers (Styrolux). The film preferably is made from a thermoplastic that can be heated and extruded into a thin film. Typically, the film is about 20 mils thick. An extruded thin film made from a thermoplastic such as vinyl can be heated to a temperature at which it is malleable (or held at the same temperature at which it has just been extruded into a film) and embossed on one side by pressing that side against the flexographic plate 500. When a thermoplastic film is embossed by the plate 500, the film is concomitantly further extruded to a thickness of about 2.8 mils, and the imprinted image is typically between about 2 microns (0.08 mils) and about 3 mils in depth, depending upon the image requirements and the thickness of the film. An advantage of hot embossing is that the resulting imprint is deeper and, thus, creates a visually impressive optical device such as a lens or a holographic image or texture.

In the step 80 of tentering the film 700, the film 700 is heated and stretched from a thick gauge narrow film down to a thin gauge film at a wider width. The film is typically heated to 325 to 350 degrees Fahrenheit (approximately 170 degrees C.) for tentering, to render the film sufficiently pliable and ductile yet still sufficiently strong to resist tearing apart. Prior to tentering, the film can be 5 mils to about 6 mils thick and about 25″ to about 26″ wide. After tentering, the film can be 1.8 mils to about 2 mils thick and about 51″ to about 52″ wide. Thus, the film 700 is preferably stretched to about 180% to 200% of its original surface area with no reduction in the film properties until the film has been made into a sleeve. When the film 700 is released and cooled after tentering, it often snaps back somewhat, but still preferably remains stretched to greater than about 180% of its original surface area. When the film is tentered, the optical or holographic devices that have been embossed into the film stretch along with the remainder of the film, retaining their emboss and thus their optical or holographic properties. None of the embossed features used to create optical lenses, holographic images, or other optical devices, are damaged by tentering.

In the step 90 of storing the film 700, the tentered film is stored in a form for subsequent shrinkage onto a portion of product. The material can be stored in various forms depending on this thickness, such as in a roll or as flat sheets. Alternately, the tentered film may be sleeved into a generally cylindrical or truncated conical shape or sleeve for later application around an article or product. Although the sleeve itself preferably has a simple shape, it can be used to shrink wrap products having complex contours and curves. Prior to shrinking, the sleeve is placed so as to surround the portion of the product sought to be shrink wrapped. Sleeving has no detrimental effect on the optical devices embossed in the film.

In the process 110, as shown in FIG. 5, the steps of providing an embossing tool 120, embossing the film 160, tentering the film 180, and storing the film 190 are substantially similar to the corresponding steps 20, 60, 80, and 90 of the process 10. The process 110 further includes a step 185 of printing on the film, wherein inks are used to print a graphical image and/or text onto the surface 714 of the film 700 opposite the surface 712 of the film 700 that was embossed. Step 185 is optional—the film need not be printed on. Printing on the film is preferably done subsequent to the tentering step 180 but prior to the storing step 190, to achieve the least distortion of the printed image and text when the film is later shrink fit around a product.

In the process 210, as shown in FIG. 6, the steps of providing an embossing tool 220, embossing the film 260, and tentering the film 280 are substantially similar to the corresponding steps 20, 60, and 80 of the process 10. The process 210 further includes a step 295 of shrinking the film, in place of the step 90 of storing the film of the process 10. In the step 295 of shrinking the film 700, the sleeve of film is heated in a steam tunnel, causing the film to shrink significantly in surface area (and, thus, causing the sleeved film to shrink in circumference). During the shrinking step 295, the film also heat seals itself. Shrinkage factors can be achieved up to about 75%, so that a tentered and sleeved film can shrink to about 25% of its pre-shinkage size. The large shrinkage factors enable the sleeve to snugly match the contour of any article or product about which the sleeve is placed. When the film shrinks, the larger portions of the product prevent the film from shrinking further but the smaller portions of the product allow the film to continue shrinking until it contacts the product. The film is sufficiently strong that it does not tear or crack where it is restrained from shrinking as much as it would otherwise, if not restrained. As the film shrinks, the optical devices that have been embossed into the film shrink along with the remainder of the film, retaining their embossed elements and, thus, their optical and/or tactile properties. None of the embossed features used to create optical lenses, holographic images, or other optical devices, are damaged by shrinking. As a result, the finished product, wrapped in shrink film, displays the intended holographic images or textures, optical lenses, or other optical devices that were previously embossed into the film.

In the process 310, as shown in FIG. 7, the steps of providing an embossing tool 320, embossing the film 360, and tentering the film 380, and shrinking the film 395 are substantially similar to the corresponding steps 220, 260, 280, and 295 of the process 210. The process 310 further includes a step 388 of sleeving the film prior to the step of shrinking the film 395. In the sleeving step 388, the tentered film is be sleeved into a generally cylindrical or truncated conical shape or sleeve for application around an article or product. Although the sleeve itself preferably has a simple shape, it can be used to shrink wrap products having complex contours and curves. Prior to shrinking, the sleeve is placed so as to surround the portion of the product sought to be shrink wrapped. Sleeving has no detrimental effect on the optical devices embossed in the film.

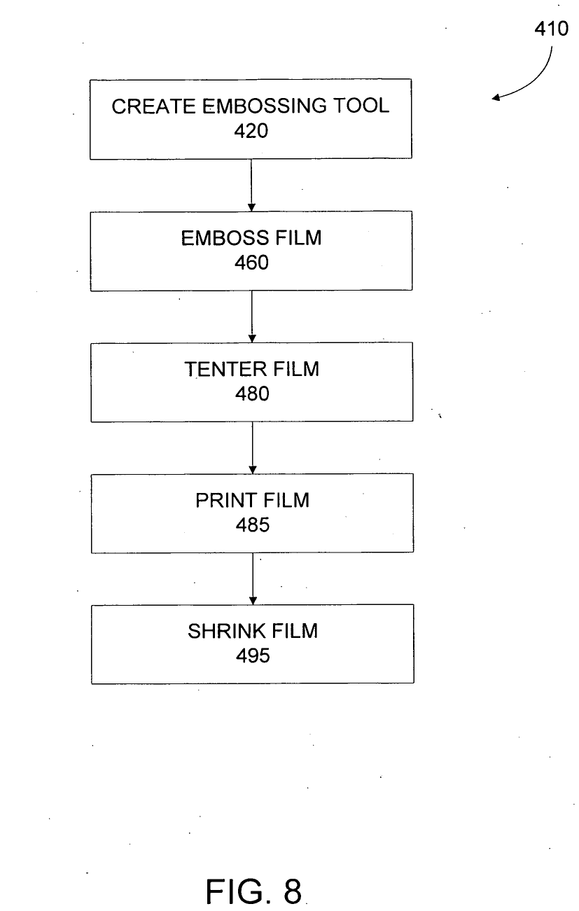

In the process 410, as shown in FIG. 8, the steps of providing an embossing tool 420, embossing the film 460, and tentering the film 480, and shrinking the film 495 are substantially similar to the corresponding steps 220, 260, 280, and 295 of the process 210. The process 410 further includes a step 385 of printing on the film, wherein inks are used to print a graphical image and/or text onto the surface 714 of the film 700 opposite the surface 712 of the film 700 that was embossed. Step 385 is optional—the film need not be printed on. Printing on the film is preferably done subsequent to the tentering step 380 but prior to the shrinking step 395, to achieve the least distortion of the printed image and text when the film is later shrink fit in step 395 around a product.

Embossed stretch films as disclosed herein could be used in traditional shrink wrap applications, as well as applications such as vehicle wraps for advertising or product package for counterfeiting prevention.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

We claim:

1. A process for manufacturing a shrink film having one or more embossed devices, comprising steps of:
providing an embossing tool shaped to form one or more embossed devices in a film;
embossing the film by contacting the embossing tool with the film to form the one or more embossed devices in the film;
tentering the film; and
storing the tentered film for subsequent heat shrinkage.

2. The process of manufacturing a shrink film of claim 1, wherein the step of providing an embossing tool comprises:
creating a digital image having one or more embossed device; and
transferring the digital image to the embossing tool.

3. The process of manufacturing a shrink film of claim 1, wherein the embossing tool is a flexographic plate.

4. The process of manufacturing a shrink film of claim 1, wherein the embossing tool is an electroformed nickel shim.

5. The process of manufacturing a shrink film of claim 1, wherein the embossing step comprises
mounting the embossing tool to a cylindrical embossing roller; and
extruding the film between the embossing tool and an opposed roller.

6. The process of manufacturing a shrink film of claim 1, wherein the embossing step comprises:
mounting the embossing tool to a cylindrical embossing roller and extruding an embossing belt between the embossing tool and an opposed roller; and
routing the embossing belt across a cylindrical embossing roller and extruding the film between the embossing belt and an opposed roller.

7. The process of manufacturing a shrink film of claim 1, further comprising a step of printing on the film.

8. The process of manufacturing a shrink film of claim 7, wherein the printing step occurs after the tentering step but before the storing step.

9. The process of manufacturing a shrink film of claim 1, wherein in the tentering step the film is stretched to at least 180% of its original surface area without damaging the embossed devices.

10. The process of manufacturing a shrink film of claim 1, further comprising the step of shrinking the film onto a portion of a product by heating the film above a threshold temperature.

11. The process of manufacturing a shrink film of claim 10, wherein the film is formed into a sleeve around the portion of the product before the film is heated.

12. The process of manufacturing a shrink film of claim 10, wherein in the shrinking step the film is shrunk by as much as about 75% without damaging the embossed devices.

13. The process of claim 1, wherein the embossed devices are optical devices.

14. The process of claim 13, wherein the optical devices are selected from the group consisting of holographic images, holographic textures, and optical lenses.

15. The process of claim 1, wherein the embossed devices are tactile devices.

16. The process of claim 15, wherein the tactile devices are selected from the group consisting of static images, textured patterns, and graphical text.

17. A process for manufacturing a shrink film having at least one embossed device, comprising steps of:
providing an embossing tool shaped to form the at least one embossed device;
extruding the film across the embossing tool to form the at least one embossed device in the film;
tentering the film; and
storing the tentered film for subsequent heat shrinkage.

18. The process of manufacturing a shrink film of claim 17, wherein the embossing tool is a flexographic plate.

19. The process of manufacturing a shrink film of claim 17, wherein the embossing tool is an electroformed nickel shim.

20. The process of manufacturing a shrink film of claim 17, further comprising a step of printing on the film after the tentering step but before the storing step.

21. The process of manufacturing a shrink film of claim 17, wherein in the tentering step the film is stretched to at least 180% of its original surface area without damaging the embossed devices, and wherein the film has material properties that allow for the material to be shrunk by as much as about 75% without damaging the embossed device.

22. The process of manufacturing a shrink film of claim 17, wherein the embossed device includes one or more of a lens and a holographic image.

23. The process of manufacturing a shrink film of claim 17, wherein the embossed device includes a tactile textured pattern.

24. A process for making a shrink film for use in decorating a portion of a product, the film having at least one embossed device, the process comprising steps of:
providing an embossing tool shaped to form the at least one embossed device;
extruding the film across the embossing tool to form the at least one embossed device in the film;
tentering the film; and
shrinking the film by heating the film above a threshold temperature.

25. The process of manufacturing a shrink film of claim 24, wherein the film is formed into a sleeve around the portion of the product before the film is heated.

26. The process of manufacturing a shrink film of claim 24, wherein in the tentering step the film is stretched to at least 180% of its original surface area without damaging the embossed device.

27. The process of manufacturing a shrink film of claim 24, wherein in the shrinking step the film is shrunk by as much as about 75% without damaging the embossed device.

28. The process of manufacturing a shrink film of claim 24, wherein the embossed device includes one or more of a lens and a holographic image.

29. The process of manufacturing a shrink film of claim 24, wherein the embossed device includes a tactile textured pattern.
